(19) United States
(12) Patent Application Publication
(10) Pub. No.: US 2025/0271373 A1
(43) Pub. Date: Aug. 28, 2025

(54) COMPONENTS AND METHODS FOR CALORIMETER SYSTEM

(71) Applicant: TA Instruments-Waters LLC, New Castle, DE (US)

(72) Inventors: David Serrell, Draper, UT (US); Donald J. Russell, Mapleton, UT (US); Joshua Reinholdt Bladh, Provo, UT (US)

(21) Appl. No.: 19/061,540

(22) Filed: Feb. 24, 2025

Related U.S. Application Data
(60) Provisional application No. 63/557,003, filed on Feb. 23, 2024.

(51) Int. Cl. G01N 25/48; G01K 17/00

(52) U.S. Cl. CPC G01N 25/4866; G01K 17/006; G01N 25/4833

(57) ABSTRACT

A thermal enclosure for a differential scanning calorimeter (DSC) instrument comprises a plurality of first thermal shields, each first thermal shield constructed and arranged for positioning about a DSC unit of a plurality of DSC units coupled to a temperature control plate; and a second thermal shield constructed and arranged for positioning about the plurality of DSC units and the plurality of first thermal shields.

### RELATED APPLICATIONS

This application claims the benefit of the earlier filing date of U.S. Patent Application Ser. No. 63/557,003 filed Feb. 23, 2024 and titled “Components and Methods for calorimeter System” the entirety of which is incorporated herein by reference.

This application is related to U.S. Non-Provisional patent application Ser. No. 16/598,088, filed Oct. 10, 2019, entitled “High Sample Throughput Differential Scanning calorimeter,” which is incorporated herein in its entirety by reference.

### FIELD

The technology generally relates generally to calorimetry systems. More particularly, the technology relates to the temperature control and sealing of one or more differential scanning calorimeter instruments having a high sample throughout.

### BACKGROUND

calorimeters are instruments that may be used to measure changes in the energy of a sample of a material by measuring the heat flow between the sample and its surroundings. A differential scanning calorimeter (DSC) is a type of calorimeter instrument that can be used to measure properties of biologic sample, nano-sized materials and polymers. Heat flows associated with heating or cooling a sample or with thermal transitions in samples may be determined. DSCs typically have at least one sample cell and at least one reference cell. In a typical DSC measurement, the temperatures of a sample cell and a reference cell are increased or decreased in a controlled manner, although some measurements may be done at a single temperature. In temperature ranges in which the sample does not undergo a transition, the heat capacity of the sample may be measured by measuring the differential heat flow needed to heat or cool the sample compared to the reference. When the temperature of the sample and of the reference is changed, the sample reaches a transition temperature associated with heating or cooling caused by an exothermic or endothermic phase transition, the differential heat flow to or from the sample compared to the heat flow to or from the reference may be used to determine the transition temperature and to calculate the enthalpy of the transition. Similarly, when the sample includes biomolecules, factors associated with the folding and stability of biomolecules may be determined by DSC measurements.

It is desirable to analyze large numbers of samples during a DSC instrument measurement period. In doing so, there is a need to protect a plurality of DSC units, each comprising a sample cell and a reference cell, from an ambient environment, and in doing so provide independent temperature control of a plurality of DSC units. In addition, there is a need to seal the DSC units to prevent vaporization, leaks, and accidental spills of the samples.

### SUMMARY

In one aspect, a thermal enclosure for a differential scanning calorimeter (DSC) instrument comprises a plurality of first thermal shields, each first thermal shield constructed and arranged for positioning about a DSC unit of a plurality of DSC units coupled to a temperature control plate; and a second thermal shield constructed and arranged for positioning about the plurality of DSC units and the plurality of first thermal shields.

In another aspect, a microfluidic device (MFD) protective lid comprises a spring element; a base element; and at least one pin extending between the spring element and the base element to apply a vertical force from the spring element to at least one MFD under the base element.

In another aspect, a method for preparing a microfluidic chip for a calorimeter instrument, comprises preparing a tray of microfluidic chips; preparing a cover slip cartridge for the microfluidic chips; filling, by at least one pipette, each of the microfluidic chips with a sample; placing a cover slip from the cover slip cartridge over the microfluidic chips; applying a sample press to couple the cover slip to each microfluidic chip.

In another aspect, a method for loading a sample into a calorimeter instrument, comprises: lifting a lid of the calorimeter instrument to access inner lids; removing the inner lids; placing a plurality of biologic sample chips each with an attached cover clip and arranged into columns into the interior of the calorimeter instrument; placing the inner lids over tops of columns of the biologic sample chips; and lowering an outer lid and a latch instrument so that the calorimeter instrument can perform an operation on the biologic sample chips.

### BRIEF DESCRIPTION OF THE DRAWINGS

The above and further advantages of embodiments of the present inventive concepts may be better understood by referring to the following description in conjunction with the accompanying drawings, in which like reference numerals indicate like elements and features in the various figures. Appended alphabetic characters may be used to distinguish between two or more like elements or features in a drawing. For clarity, not every element may be labeled in every figure. The drawings are not necessarily to scale, emphasis instead being placed upon illustrating the principles of features and implementations.

FIG. 1 is a perspective view of an embodiment of a DSC instrument.

FIG. 2 is another perspective view of the DSC instrument of FIG. 1.

FIG. 3A is an assembled view of a thermal enclosure for the DSC instrument of FIGS. 1 and 2, in accordance with some embodiments.

FIG. 3B is an exploded view of the thermal enclosure of FIG. 3A.

FIGS. 4A, 4B and 4C are views of one embodiment of a microfluidic device (MFD) that can be used with the DSC instrument of FIGS. 1 and 2.

FIGS. 4D and 4E are views of another embodiment of a microfluidic device (MFD) that can be used with the DSC instrument of FIGS. 1 and 2.

FIG. 5 is an exploded view of an MFD protective lid, in accordance with some embodiments.

FIG. 6 is an assembled view of the MFD protective lid of FIG. 5.

FIG. 7 is a close-up view of the MFD protective lid of FIGS. 5 and 6.

FIG. 8 is a perspective view of the MFD protective lid of FIGS. 5-7 coupled to a DSC instrument.

FIG. 9 is a cross-sectional view of a DSC instrument including the thermal enclosure of FIGS. 1-3B and the MFD protective lid of FIGS. 5-8, in accordance with some embodiments.

FIGS. 10-12 are views of an embodiment of a disposable MFD filling tray and alignment tweezers.

FIG. 13 is a flow diagram of a method for preparing a microfluidic chip for a calorimeter instrument, in accordance with some embodiments.

FIG. 14 is a flow diagram of a method for loading a microfluidic chip into a calorimeter instrument, in accordance with some embodiments.

FIG. 15 is a views of a main instrument lid lifted to access inner lids inside a rapid screening (RS)-DSC main compartment according to the method of FIG. 14, which includes the DSC components of FIGS. 1-9.

### DETAILED DESCRIPTION

Reference in the specification to an “embodiment” or “example” means that a feature, structure or characteristic described in connection with the embodiment is included in at least one example of the teaching. References to an embodiment within the specification do not necessarily all refer to the same embodiment.

The present teaching will now be described in more detail with reference to embodiments shown in the accompanying drawings. While the present teaching is described in conjunction with various embodiments, it is not intended that the present teaching be limited to such embodiments. On the contrary, the present teaching encompasses various alternatives, modifications and equivalents, as will be appreciated by those of skill in the art. Those of ordinary skill having access to the teaching herein will recognize additional implementations, modifications and embodiments, as well as other fields of use, which are within the scope of the present disclosure.

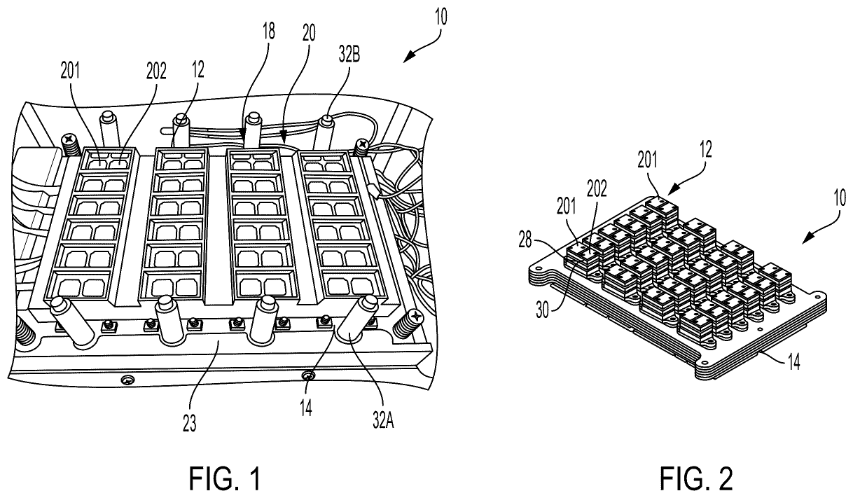

FIG. 1 is a perspective view of an embodiment of a DSC instrument 10. FIG. 2 is another perspective view of the DSC instrument 10 of FIG. 1.

The instrument 10 may include multiple DSC units 12 arranged in an array, i.e., rows and columns 18 on a thermal substrate (temperature control plate) 14. In some embodiments, a metal frame 23 can be positioned over the temperature control plate 14 and including one or more openings for receiving a plurality of guide pins 32A, 32B and exposing the top surfaces of the DSC units 12 serving as apertures for receiving pairs of microfluidic devices (MFDs), or sample and reference pairs described herein. The guide pins 32A, 32B may be formed of a PEEK material or the like for providing thermal conductivity, but not limited thereto. The DSC instrument 10 can include other components, not shown, such as a temperature control module, a processor, and a user interface (UI) module. As used herein, a single DSC unit 12 measures heat flows associated with heating or cooling an individual sample, and/or the heat flow associated with thermal transitions in the individual sample.

As illustrated, the DSC instrument 10 may include six DSC units 12. It will be appreciated that other numbers of multiple DSC units 12 may be used. The DSC units 12 are shown arranged in a 6×4 array allowing the DSC instrument to run 24 samples in parallel. However, other configurations are possible, including groupings that are not arranged according to a rectangular grid array. For manufacturing convenience and efficient operation (e.g., loading and unloading of samples), a rectangular array of DSCs may be preferred.

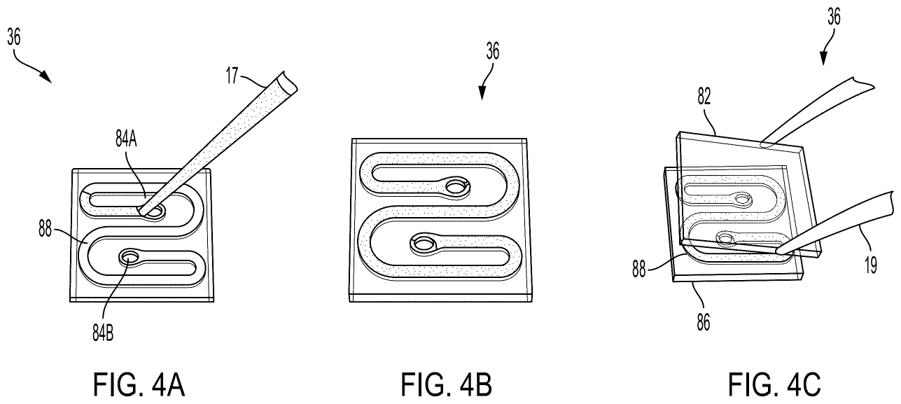

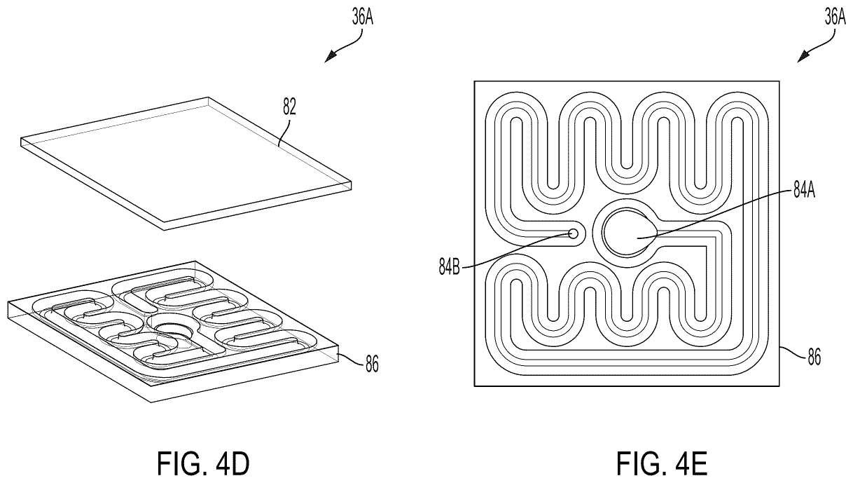

In some instances, a DSC unit 12 includes a single reference cell 201 and further includes a single sample cell 202 that receives a sample to be analyzed. For example, referring to FIGS. 4A-4E, a sample chip 36, 36A can be positioned at a sample cell 202 shown in FIG. 1. In some embodiments, a tray of chips 13 (see FIG. 8) may be positioned at the DSC instrument 10. Th chips 36 may be formed of glass or related material, but not limited thereto. The chips 36 in the tray 13 may be vertically aligned with the arrangement of DSC units 12 for positioning the chips. The tray may include apertures located in a frame at a position that is aligned with a DSC unit 12 when the chip tray is loaded into the DSC instrument 10 so that at least one of a reference platform 28 and a sample platform 30 (see FIG. 2) extends through the aperture when the frame is inserted into the DSC instrument 10. The reference platform 28 may be constructed and arranged to receive a reference container or cell 201, optionally a reference chip, and a sample platform 30 for receiving a sample container or cell 202, optionally a sample chip. In one embodiment, the platforms 28 and 30 are formed of aluminum. Preferably, the reference and sample cells are similar in structure, size and material composition. During operation of the DSC instrument 10, the reference cells are typically empty while some or all the sample cells include samples to be analyzed. In some embodiments, the reference cells may differ in structure from the sample cells. For example, the reference cells may be solid blocks while the sample cells may include an internal void, such as a chamber or fluidic channel, to receive a liquid sample.

Each DSC unit 12 may be in thermal communication with the temperature control plate 14. For example, each DSC unit 12 may be mounted to a surface of the temperature control plate 14 to establish direct thermal communication by contact. In some embodiments, each DSC unit 12 is mounted to the temperature control plate 14 using screws or bolts through holes in the bottom layers of the vertical stack. The temperature control module (not shown) may include one or more heating and/or cooling devices in thermal communication with the temperature control plate 14 to control a temperature of the plate 14. In some embodiments, the temperature control plate 14 is machined from a single metal block. In other embodiments, the plate 14 includes multiple metallic layers that are diffusion-bonded together to produce a metallic block having a higher thermal conductivity laterally across the block than vertically through the block. For example, the plate 14 may include layers of a highly thermally conductive metal, such as copper, silver, gold or aluminum, alternating with layers of a less thermally conductive metal, such as stainless steel, Inconel, bronze or titanium.

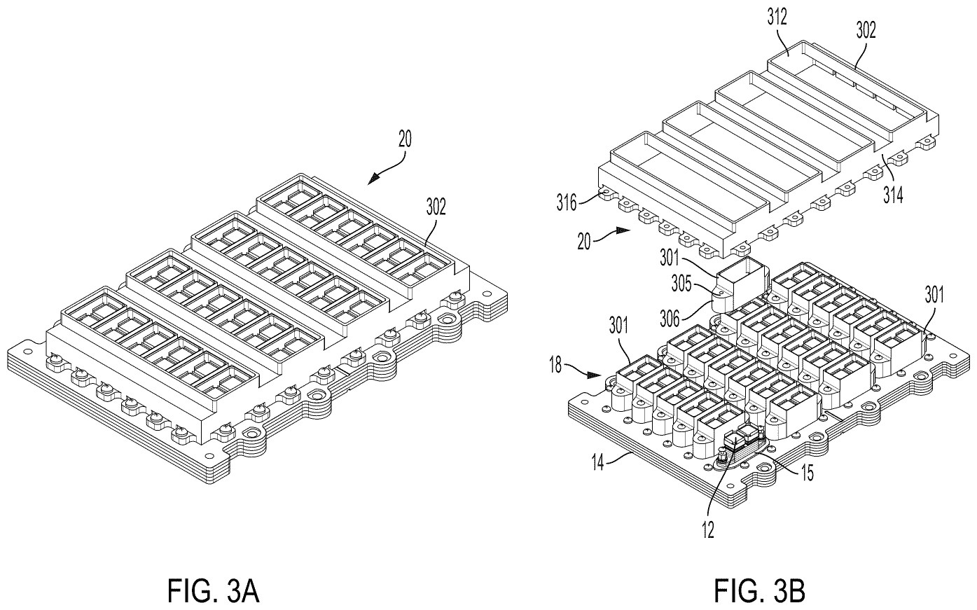

In some embodiments, as shown in FIG. 1 and also shown in FIGS. 3A and 3B, the DSC units 12 may be provided in an enclosure 20 to achieve thermal and pressure isolation from the local environment. The enclosure 20 may be constructed and arranged as a two-part thermal shield comprising a plurality of first thermal shields 301, referred to as inner shields, each enclosed about a DSC unit 12 and a larger second thermal shield 302, referred to as an outer shield, constructed and arranged for positioning about the first thermal shields 301. In some embodiments, the first and second thermal shields 301, 302 are formed of a metal or material providing thermal conductivity, such as aluminum, nickel-plated, and so on.

For example, each first thermal shield 301 may be positioned about a periphery of a DSC 12, and more specifically, about the reference cell 201 and sample cell 202 of a DSC 12. In the example shown, the DSCs 12 may be arranged into four columns 18, each column including six DSCs 12, for a total of 24 DSCs 12. A first thermal shield 301 is provided for each of the 24 DSCs 12. Each of the first thermal shields 301 has a same or similar shape and configuration to provide consistent thermal features across all the shields 301. The first thermal shields 301 may provide an individual inner shield for each calorimeter 12. The first thermal shields 301 may include an extension 305 from a sidewall of the shields 301. A hole 306 may extend through the extension 306 for receiving a screw, bolt, or other attachment mechanism that couples the first thermal shield 301 to a surface of the temperature control plate 14 to which the DSCs 12 are mounted. In some embodiments, a channel 15, or groove, slot, trench, indentation, or the like, may be formed in the temperature control plate about some or all of the periphery of each DSC unit 12. The channel 15 may be constructed and arranged to receive a bottom portion of the first thermal shield 301.

The second thermal shield 302 may be constructed and arranged into multiple sections, each section configured for positioning over a column 18 of DSCs 12 and corresponding first thermal shield 301 to provide protection for the DSCs 12 against an ambient environment. The second thermal shield 302, like the first thermal shields 301, may be coupled to the temperature control plate 14, and thermally grounded. The second thermal shield 302 may include a plurality of extensions 316 with holes for receiving screws, bolts, or other coupling mechanisms to fasten the second thermal shield 302 to the temperature control plate 14.

During operation of the DSC instrument 10, the temperature of the DSC units 12 may be controlled, at least in part, by controlling the temperature of the temperature control plate 14. For example, a heater can be used to increase the plate temperature in a controlled way, such as by implementing a linear temperature ramp. In another example, a cooling system, for example, air or liquid (e.g., water) under the diffusion plate for cooling the temperature control plate 14. In some embodiments, the cooling system may include a set of cooling layers, Peltier modules, or the like for reducing the plate temperature. the temperature control module may comprise a cooling layer in thermal communication with the temperature control plate. In other embodiments, the instrument 10 may include a heat sink, which may be in thermal communication with the cooling layer. In other embodiments, the instrument 10 may include a cooling fan or other source of air flow and to allow the temperature control plate 14 to provide a sufficiently uniform and controlled temperature environment of the DSC units 12 in cooperation with the thermal enclosure 20 which provides temperature-related isolation of the individual DSC units 12. In some embodiments, a heating system may include one or more layers including at least one opening. Here, a cooling layer of the cooling system can be in thermal communication with the temperature control plate through the at least one opening.

FIGS. 4A, 4B and 4C are views of an embodiment of a sample chip 36 that can be used with the DSC instrument of FIGS. 1 and 2. FIGS. 4D and 4E are views of another embodiment of a sample chip 36A that can be used with the DSC instrument of FIGS. 1 and 2. In particular, the sample chip 36, 36A can be similar to or the same as a single sample cell 202 of FIGS. 1 and 2 that receives a sample to be analyzed.

The sample chip 36 may include a block having a cover slip 82, referred to as a cover slip, and a bottom chip 86 with two ports 84A and 84B covered by the cover slip 82. Preferably, the block material may be made of an inexpensive chemically inert material that can be easily manufactured to the desired structure and which avoids any chemical interaction with the sample. Examples of chemically inert block material include fused silica, silicon and polydimethylsiloxane. Although such materials have poor thermal conductivity compared to metals, the chip thickness results in a relatively small impact to instrument performance. When the sample chip 36 is loaded on one of the DSC units 12, the bottom surface 86 is in contact with the top of the sample platform. The bottom chip 86 can be coupled to the cover slip 82 by an adhesive or other coupling mechanism. A coupling apparatus 19, for example, with tweezers, clamping apparatus, or related tool may be used to coupling the chip portions 86, 82 together. The adhesive may be a silicone-based adhesive, or other bonding material that does not affect signal performance during operation performed by the instrument. Preferably, the bottom surface is smooth and flat to achieve continuous contact across the surface and to improve thermal conduction between the chip 36 and platform. In some embodiments, the thickness t of the chip 36 has a value in a range from about 0.5 mm to about 1.5 mm.

The chip 36, or more specifically the bottom chip 86, may include at least one access hole 84A for providing an input to a fluidic channel 88. In other embodiments, the channel 88 may be serpentine-shaped (for example, as shown) and one end is in communication with the access hole 84A. In other embodiments, the bottom chip 86 includes two access ports 84A, 84B, and the channel 88 extends from one port 84A to an opposite end at the other port 84B. As shown in FIGs. The second access port 84B may be a bleeder hole which is smaller than the injection port 84A. The serpentine channel 94 (e.g., a microfluidic channel) embedded in the chip 90 may allow for a greater channel length than a sample chip having a direct channel path between ports. In alternative embodiments, the channel 88 may be routed differently through the block and may have a chamber defined along the channel length to accommodate a greater sample volume. As shown in FIG. 4A, sample can be introduced into the channel 88 through one of the ports 84 and air displaced from the channel 88 can exit the chip 36 at the other port 84. In some alternative embodiments, the sample chip has a single aperture to receive the sample. A known volume of sample may be inserted into the channel 88 using a pipette 17. By way of non-limiting numerical examples, a volume of the channel 88 may be in a range from about 10 μL to about 40 μL which is less than the volumes of sample cells for many conventional DSC instruments which sometimes use volumes of 300 μL or more. Optionally, a seal can be secured to the sample chip 36 on the top surface 82 to prevent vaporization of the sample before and during the sample analysis to prevent sample loss and to prevent a heat signal due to evaporation from the sample chip 36, thereby degrading thermal measurements. The seal can also prevent sample leaks and accidental spills that might otherwise contaminate other instrument components. As described herein, other accessories can contribute to the seal.

In some uses, the sample chips 36 are preloaded with samples at one location prior to delivery of the sample chips 36 to another location where the sample chips 36 are loaded into the DSC instrument for analysis. The loaded sample chips may be inserted into one or more trays 13 (see FIG. 8) for convenience in subsequent handling and transportation. For example, a chip tray 13 may include a frame having 24 pairs (6×4 array described herein) of square openings (i.e., apertures), each for a reference and sample chip pair. In some embodiments, the tray 13 may be partially or fully populated with empty sample chips and some or all these sample chips 36 may be loaded while the chips remain in the tray 13. Subsets of the empty sample chips may be protected by a protective layer to prevent contamination before use. In this instance, the protective layer may be peeled back or otherwise removed to expose a subset of the sample chips for loading while other protective layers remained over other subsets of the chips to preserve them for sample loading and analysis at a later time. Each sample chip can be individually sealed once it is loaded with a sample. Preferably, the sample chip 36 may be discarded after analysis of the sample is completed. Advantageously, there is no time expended for cleaning the sample chip 36 for a subsequent sample analysis and the opportunity for cross-contamination due to incomplete or ineffective cleaning of the sample chip 36 is substantially reduced or eliminated.

Reference chips can be manufactured to have a structure like that of the sample chip 36. For example, the reference chips can be loaded with a buffer and the sample chips loaded with the same buffer plus a protein to be analyzed. Optionally, the reference chips may not be loaded. In alternative embodiments, the reference chips do not include a channel or other internal volume. For example, the reference chips may be solid blocks of identical thermally conductive material without ports or any internal volume.

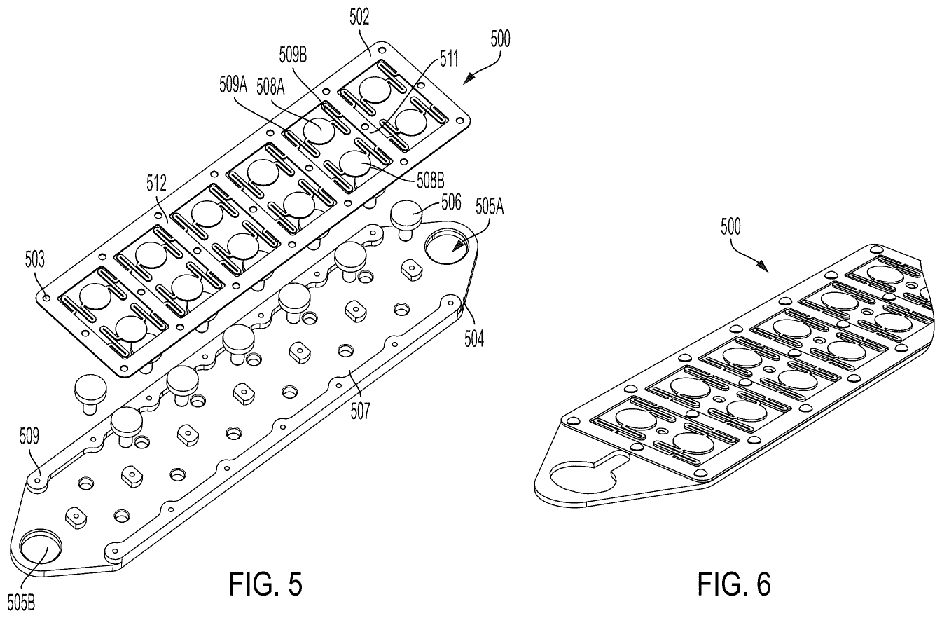

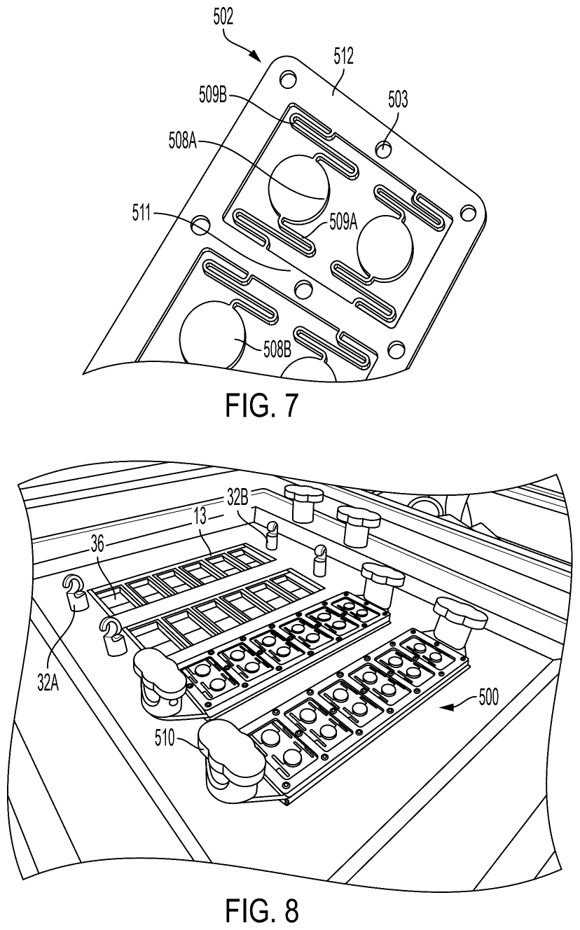

FIGS. 5-8 are views of an MFD protective lid 500, in accordance with some embodiments. The MFD protective lid 500 is constructed and arranged to apply a force vertically to the chip 36. Although the chip 36 may include an adhesive used for press-fitting the top and bottom portions shown in FIG. 4A-4E, an additional force can be applied by the lid 500 to prevent leaking of the chip 36.

As shown in FIGS. 5-8, the MFD protective lid 500 includes in some embodiments a spring element 502, a base element 504, and a plurality of pins 506 extending between the spring element 502 and the base element 504.

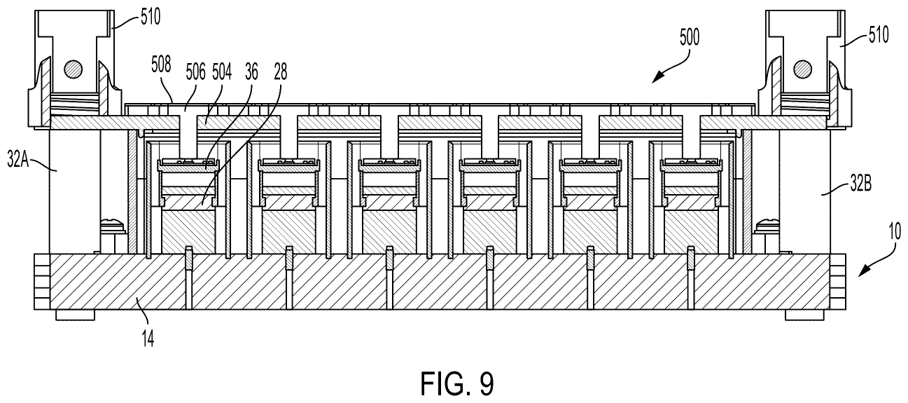

The base element 504 may be constructed and arranged for positioning on a DSC instrument 10, for example, shown in FIG. 9. In some embodiments, the base element 504 may be formed of aluminum material, but not limited thereto. In some embodiments, the base element 504 has an elongated configuration for positioning over a column 18 of DSCs 12 shown in FIG. 1. In some embodiments, the base element 504 is configured for positioning over a section of the enclosure 20 shown in FIGS. 1-3B enclosing a column 18 of DSCs 12. The base element 504 includes three sets of holes.

The first set of holes may include a first hole 505A at one end of the base element 504 and a second hole 505B at a second end opposite the first end. The first hole 505A and second hole 505B may have a diameter, circumference, or the like that is dimensioned for receiving a first guide pin 32A and a second guide pin 32B extending at the ends of a column 18 and extending from the surface of the temperature control plate 14.

The second set of holes 507 may be dimensioned for receiving the elongated portions of the pins 506, so that the pins 506 can extend through the base element 504 to directly abut a set of chips 36 positioned in corresponding DSC units 12. The pins 506 may be formed of a PEEK material or other polymer, but not limited thereto.

The third set of holes 509 may be positioned about a peripheral region of the base element 504 for receiving coupling elements such as threaded screws, bolts, or the like for coupling the spring element 502 to the base element 504. The spring element 502 can be formed of spring steel or other material that provides some elasticity, or spring, features while accommodating for thermal characteristics produced during operation. The spring element 502 may be formed on a single source of steel material. The spring element 502 likewise may include holes 503 that are vertically aligned with the third holes 509 of the base element 504 so that a screw, bolt, or related coupling element is inserted through the holes 503, 509 and coupling the spring element 502 to the base element 504.

In some embodiments, the spring element 502 comprises a frame 512 that forms a periphery of the spring element 502. Inside the frame 512 may include a plurality of capping elements 508, each constructed and arranged for positioning over a pin 506, which in turn is positioned over a chip 36. Thus, each calorimeter has a same thermal path and force due to the arrangement of capping elements 508 and springs 509. The arrangement of capping elements 508 may include a first capping element 508A and a second capping element 508B for positioning over a sample chip and a corresponding reference chip of a pair. The pins 506 applying a force to the reference chips are provided to mimic the relevant pins 506 applying a force to the sample chips. This allows the thermal path to be the same for both the reference and sample chips even though the reference chips do not require a force because there is no concern about leaking by the reference chips. The capping elements 508 are collectively arranged for a column 18 of DSCs 12. Two pins 506 may be sandwiched between the first and second capping elements 508A, 508B and the pair of chips. Each pair of capping elements 508A, 508B may be separated from a neighboring pair of capping elements 508 by a separator 511. A first flat serpentine spring 509A and a second flat serpentine spring 509B may be coupled between each capping element 508 and either a separator 511 or the frame 512. The springs 509A, 509B extend 180 degrees from each other from each capping element 508 as shown. The serpentine springs 509A, 509B (generally, 509) may have a flat configuration to require less vertical space. The thickness of the spring element 502 from the top and bottom surfaces of the frame 512, capping elements 508, springs 509, and separate 511 may be uniform, i.e., a same thickness, and formed from a common material such as steel or other material that allows for some elasticity of the springs 509, which can allow the capping element 508 to move vertically when a force is applied due to the pin 506 sandwiched between the capping element 504 and the chip 36 below the pin 506.

In some embodiments, the lid 500 includes a locking mechanism 510 at each end to lock down the lid 500, and in doing so, provides a clamping force, or vertical force that is applied by the lid 500 against the chips 36, as described above. The locking mechanisms 510 may be snap knobs having a hole extending vertically through the bottom of the knob into which a guidepost is positioned. The combination of the cover slip 82, chip adhesive, and pins 506 when locked down by the locking mechanisms 510 prevent leaking at the chips 36, in particular, during increases in temperature during operation. The guide pins 32 may include helical grooves or the like that mate with a male element of the locking mechanism 510 so that when the locking mechanism 510 is rotated, a vertical clamping force is generated and the tray 13 is pushed down into the body of the instrument.

During operation, the sample chips 36, and optionally the reference chips, may be loaded into the DSC instrument 10 (see FIGS. 1, 8, and 9) manually or automatically. A force such as pressure is applied to each sealed chip 36 by the protective lid 500 to prevent evaporation or spilling of sample when the locking knobs 510 are applied to the ends of the lid 500 This is due to the spring loaded configuration of the spring element 502, which applies a force to the pins 506, which in turn apply a source of pressure to the chips 36.

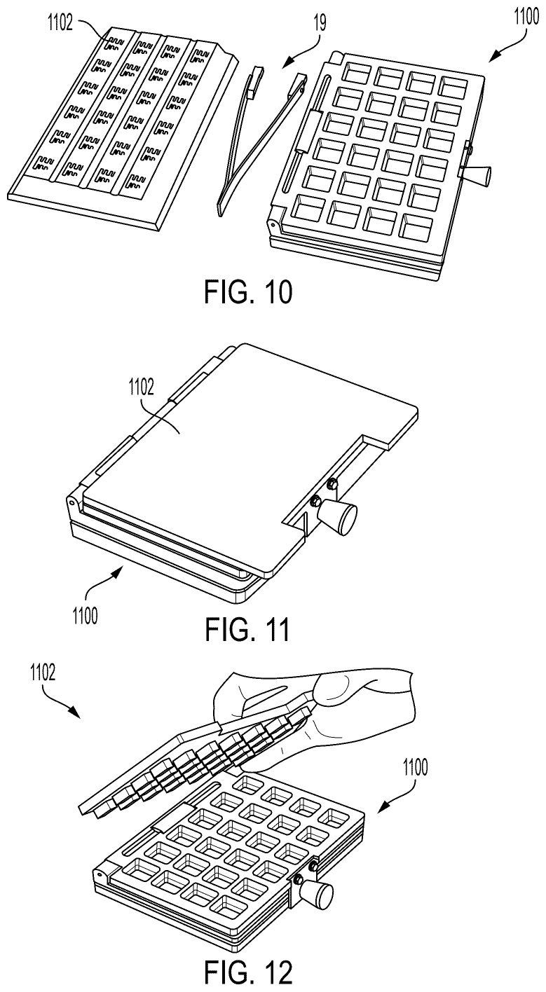

FIGS. 10-12 are views of an embodiment of a disposable MFD filling tray 1102 and alignment tweezers 19. As shown, a plurality of MFDs are provided in a disposable plastic tray 1100. The tray design and MFD orientation in the tray 1100 are intended to make sample preparation easier and more reliable. This is accomplished with the following features.

A lid on the plastic tray keeps the MFDs from falling out of position during shipping or when transferring prepared samples. The lid also keeps dust or other debris from contaminating MFDs. The lid is removed to access the MFDs but can be placed back over the tray while transporting the prepared MFDs, or to protect unused MFDs if not all 24 were used.\In some embodiments, there is a 15° tilt on the MFD: By holding the MFD at a 15° angle a pipette tip (see FIG. 4A) can more naturally be fed into the MFD opening and dispense fluid directly into the MFD channel. This prevents the opening at the pipette tip from being blocked by the flat MFD filling tray surface at the bottom of the MFD opening.

Each MFD is intentionally oriented so that the opening is facing upwards, and the channel leads down the incline. This allows the pipettor to move from MFD to MFD as they prepare samples, without needing to place or arrange the MFDs themselves.

Each position in the disposable plastic tray 1100 is labeled to correspond to a position in the RS-DSC itself. Users who wish to run experiments on dissimilar samples will be able to track which samples are in what positions in the tray and in the RS-DSC.

On either side of each MFD are small rectangular cavities. These cavities act as alignment guides to aid in the proper placement of the cover slip (see FIGS. 4A-4E) over the MFD.

With further regard to the cover slip 82 shown in FIGS. 4A-4E, the cover slip 82 can be provided in a disposable plastic cartridge. Each cover slip 82 is backed with an adhesive film and temporarily adhered to a 3M adhesive transfer liner. The adhesive transfer liner is pinned to the rigid plastic cartridge. On either side of each cover slip are small rectangular cavities, similar to the cavities on the MFD filling tray. These cavities can act as alignment aids so that cover slips 82 are picked out of the cartridge properly. A cover slip release tray 1100 can be a reusable tool to remove the cover slips from the cartridge 1102. When the cartridge is properly positioned and clamped inside the release tray 1100, the cover slips are partially released from the adhesive transfer liner.

The replaceable tips of the alignment tweezers 19 (see also FIG. 4C) fit perfectly into the alignment features of the MFD filling tray 1102 and the cover slip cartridge. If the tweezers 19 are used to lift the cover slips out of the cover slip cartridge, then, the alignment features on the MFD filling tray 1102 will guide the tweezers to place the cover slip over the MFC in proper alignment.

In some embodiments, a sample press may be used to maximize adhesion between the MFD 86 and cover slip 82 (see FIGS. 4A-4E), and therefore prevent leaks, by applying a significant amount of force to press the MFD 86 and cover slip 82 together. The sample press can be constructed to apply this force fast and easily.

The solvent systems used for preparation of biologic and biopolymer solutions are typically buffered aqueous solutions, which often contain supporting strong electrolytes (for example, NaCl or KCl) to adjust the ionic strength. While excess buffer is not required for a sample scan, having access to blank buffer can be useful for troubleshooting. It should be noted that buffers used in DSC experiments should be carefully chosen to meet the following criteria:
The pKa should be as independent as possible of the temperature.
The ΔH for proton ionization from the buffer acid should be small.
All components of the buffer/solvent solution should be thermally stable. (The buffer should not precipitate or change color on boiling.)

The following describes an experiment where an RS-DSC instrument is designed for the analysis of protein or biologic samples within typical working concentrations in the pharmaceutical industry (20-250+ mg/mL). This allows for thermodynamic understanding of the protein sample as formulated, without making modifications to the sample of interest, such as dilution. It should be noted that high sensitivity DSC experiments should be done with highly purified samples. Accepted techniques should be used for sample purification prior to solution preparation. While transition temperature (Tₘₐₓ or Tₘ) can be determined without detailed sample information, it is critical to know the solute (protein) molecular weight, concentration, and state of oligomerization prior to attempting a full thermodynamic analysis of the heat capacity data.

Typically, if a solution is heated, gas bubbles will form as the solubility of dissolved gasses (such as O₂ and N₂) is decreased with increasing temperature. If gas bubble formation occurs in the sample cells during the run, movement in the sample chips can be detected as random thermal events in the heat capacity. Degassing sample solution by pulling a vacuum of 15 to 25 inches Hg on the solution for a period of 10 to 15 min is the best practice to minimize the risk of random thermal events in the scan. An accessory degassing station is used.

The Micro Fluidic Chips (MFCs) are examples of the MFDs above which are used for the sample cell in an RS-DSC instrument, for example, provided by TA instruments, provide a platform to contain the sample during the scan and are disposed of after the scan to minimize time intensive cleaning procedures between scans. To put it briefly, the sample can be pipetted into the MFC and sealed with an adhesive-backed glass cover to contain the sample and prevent evaporation during the temperature ramp.

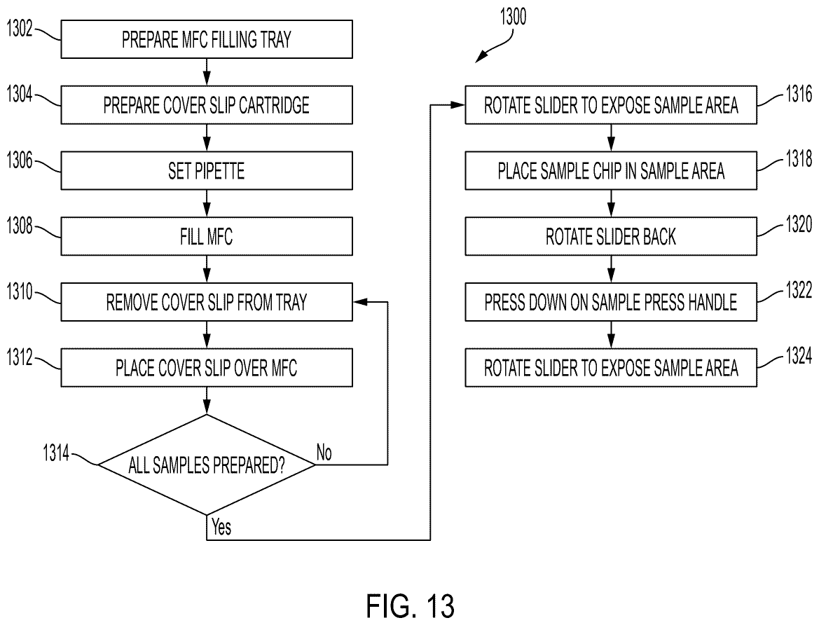

Preparation of the sample chips is facilitated with several tools provided with the RS-DSC instrument. The following provide an overview of each of these tools, and then offer a step-by-step guide for how to prepare a full set of 24 samples for an experiment in accordance with the method 1300 for preparing a microfluidic chip for a calorimeter instrument, describe with reference to FIG. 13.

In accordance with some embodiments, an MFC filling tray is provided, for example, described above. A plurality of MFCs (i.e., 24 chips, MFDs, or the like) are provided in the tray, which may a disposable plastic tray. The tray design and MFC orientation in the tray are intended to make sample preparation easier and more reliable. This is accomplished with the following features.

A lid on the plastic tray may prevent the MFCs from falling out of position during shipping or when transferring prepared samples. The lid may also keep dust or other debris from contaminating MFCs. As shown in FIGS. 9-11, the lid may be removed to access the MFCs but can be placed back over the tray while transporting the prepared MFCs, or to protect unused MFCs if not all 24 were used.

Each MFC may be intentionally oriented so that the opening faces upwards with the channel opening to the left. This allows a right-handed pipettor, for example, pipette 17 shown in FIG. 4A, to pipette into the MFC with the pipette tip pointing into the channel. (A left-handed pipettor may want to rotate the tray 180° so that the pipette tips points into the channel.) This pre-set orientation allows a pipettor to move from one MFC to the next without needing to place or arrange the MFCs.

Each position in the disposable plastic tray is labeled to correspond to a position in the RS-DSC. Users who wish to run experiments on dissimilar samples will be able to track which samples are in what positions in the tray and in the RS-DSC.

On either side of each MFC may be small rectangular cavities. These cavities act as alignment guides to aid in the proper placement of the cover slip over the MFC, for example, shown in FIGS. 4A-4E. In some embodiments, the cover slips are provided in a disposable plastic cartridge. Each cover slip is backed with an adhesive film and temporarily adhered to a 3M adhesive transfer liner. The adhesive transfer liner is pinned to the rigid plastic cartridge. On either side of each cover slip are small rectangular cavities, similar to the cavities on the MFC filling tray. These cavities act as alignment aids so that cover slips are picked out of the cartridge properly.

In some embodiments, a cover slip release tray relies on a reusable tool to remove the cover slips from the cartridge. It may be formed of a clam-like main assembly and a removable component called the leveling plane. When the cartridge is properly positioned and clamped inside the main assembly portion of the release tray, the cover slips may be partially released from the adhesive transfer liner. The leveling plane has a grid of 24 “X” shaped protrusions which fit in the 24 openings in the main assembly. The leveling plane keeps the cover slips level when the release tray is closed over a cartridge.

Referring again to the alignment tweezers 19, the tweezer tips may fit perfectly into the alignment features of the MFC filling tray and the cover slip cartridge. The tweezers 19 are designed to work with alignment features built into the cover slip cartridge and MFC filling tray to help align the cover slip when placing on the MFC.

In order to maximize adhesion between the MFC and cover slip, and therefore prevent leaks, a significant amount of force must be applied to press the MFC and cover slip together. The sample press referred to above may be used to apply this force fast and easily. A piece called the slider may rotate to allow the user to place an un-pressed sample chip on a silicone pad. The slider may rotated under the upper jaw of the press, which is lowered to compress the sample chip between two silicone pads.

Referring again to the method 1300 of FIG. 13, at step 1302, an MFC filling tray is prepared, for example, the filling tray 1102 of FIGS. 10-12. The tray may be initially in a vacuum sealed bag, which can be opened to remove the tray 1102, then placed on a clean, level surface. The lid can be removed from the tray.

At step 1304, the cover slip cartridge is prepared by removing the cartridge from a vacuum sealed back and likewise placed on a clean, level surface. The release tray may be opened by pulling on the spring-loaded knob and lifting the upper portion to about 90°. The cartridge can be in the release tray so that the cover slips are facing up. The release tray can be closed and a firm pressure is applied to the top surface of the leveling plane until the spring-loaded knob snaps into place, for example, shown in FIG. 11. During closing, a user may hear a crackling sound as each cover slip is partially released from the adhesive transfer liner. The leveling plane may be removed and set aside, flat side down, to reveal the partially released cover slips.

At step 1306, a pipette is prepared, for example, pipette 17 shown in FIG. 4A, In doing so, the pipette is to the appropriate volume and make sure an appropriately sized tip is installed on the pipette.

At step 1308, the MFCs are filled with a sample using the pipette 17. In order to avoid evaporation of samples, MFCs must be sealed with a cover slip within 5 minutes of being filled. Depending on the solution being used, it is a good rule of thumb is to fill 6 MFCs, then seal them, and repeat as needed. A user may carefully place a pipette in the proper position to avoid wetting the surface of the MFC where the cover slip must adhere. This can cause loss of sample and compromise the adhesive seal of the cover slip. Particularly viscous samples must be pipetted slowly to allow sample time to travel through the MFC channel. Pipetting of viscous sample too quickly will result in loss of sample and wetting of the top surface of the MFC. Pipetting must be done gently to avoid introducing bubbles to the MFC.

At step 1310, the alignment tweezers 19 can be used to pluck a cover slip from the release tray. In doing so, a user can apply a firm grip to the tweezers which in turn applies a force on the cover slip by pressing the tweezers lightly downward against the cover slip, then squeezing tightly on the tweezers before lifting the cover slip out of the release tray.

At step 1312, the cover slip removed from the release tray can be positioned over a filled MFC. For best alignment, use the alignment feature built into the MFC filling tray to guide the tweezers as the cover slip is placed over the MFC. Steps 1310 and 1312 may be repeated until all desired samples are prepared.

At step 1316, the slider can be rotated to expose the sample area.

At step 1318, a single sample chip is placed in the sample area so that it rests flat on the silicone pad. The sample chip must be completely on the silicone pad and not partially on the edge of the sample area.

At step 1320, the slider rotates back until it stops.

At step 1322, the user can press down on the handle of the sample press until it stops, hold it for one second, and pull it back up. The user can keep ahold of the handle for this entire step to prevent the handle from “popping” up, which could cause the sample chip to fall out of place and become contaminated on some unprepared surface

At step 1324, the slider is rotated to expose the sample area again and so that the sample chip can be removed. The sample chip can be placed back in the MFC filling tray in its proper location.

Steps 1318-1324 can be repeated until all sample chips have been pressed.

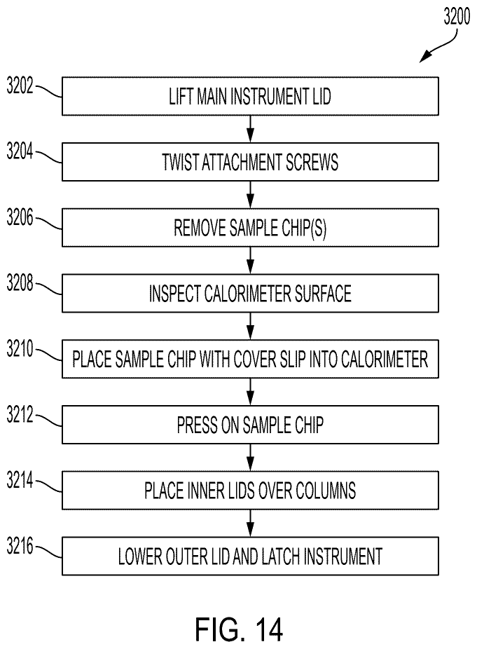

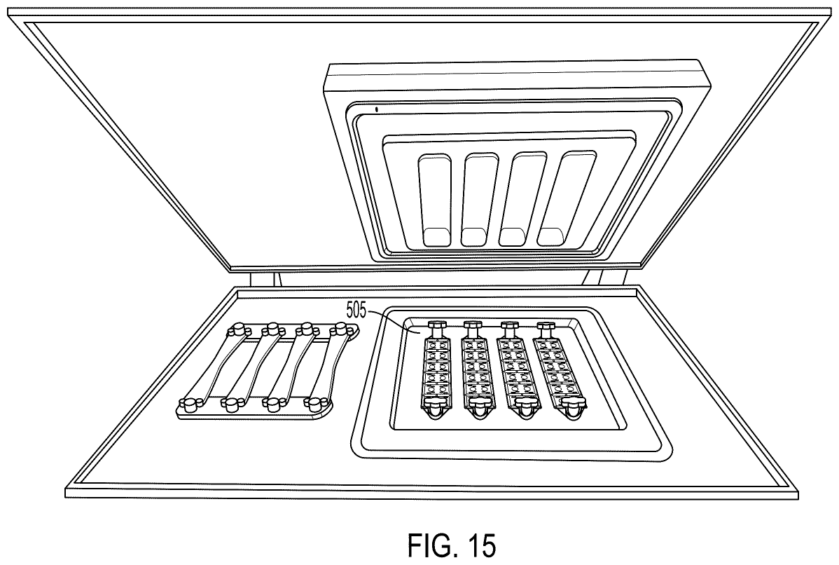

In accordance with method 3200 shown in FIG. 14, after the sample chips are prepared, they are ready to be loaded into the instrument using the following procedure.

At step 3202, the main instrument lid can be lifted to access the inner lids inside the RS-DSC main compartment above the calorimeters.

At step 3204, the locking mechanisms, for example, the locking mechanism 510 including knobs, attachment screws, or the like, are twisted to remove and lift the inner lids straight up to access the calorimeters. Lids and attachment screws can be stored to the left of the calorimeters as indicated while accessing the cells, shown in FIG. 15.

At step 3206, the sample chips can be removed from the sample side of the calorimeter. As shown in FIG. 35, exposed calorimeter cells with sample and reference highlighted. Reference cells contain peek blank chips that will remain in place.

At step 3208, one may inspect the calorimeter surface and gently brush with a cotton swab to remove any debris. Debris under the sample chip may result in noise in the thermogram and can cause an artificial increase in Tₘₐₓ.

At step 3210, one may place prepared biologic sample chip with the cover slip up into the calorimeter. The sample side must make contact with the calorimeter. While 90 degree rotations do not matter, if the sample chip is placed upside down the data will be invalid.

At step 3212, one may gently press on sample chip and ensure placement inside the calorimeter walls and good contact with the calorimeter.

At step 3214, after placement of all sample chips, the inner lids can be placed over the top of the columns and pressed in place with the attachment screws.

At step 3214, the outer lid and latch instrument can be lowered by turning the dial.

While the present disclosure has been shown and described with reference to specific examples, it should be understood by those skilled in the art that various changes in form and detail may be made therein without departing from the scope of the invention as recited in the accompanying claims.

What is claimed is:

1. A thermal enclosure for a differential scanning calorimeter (DSC) instrument, comprising:
a plurality of first thermal shields, each first thermal shield constructed and arranged for positioning about a DSC unit of a plurality of DSC units coupled to a temperature control plate; and
a second thermal shield constructed and arranged for positioning about the plurality of DSC units and the plurality of first thermal shields.

2. The thermal enclosure of claim 1, further comprising a channel in the temperature control plate about a periphery of each DSC unit, the channel constructed and arranged to receive a bottom portion of the first thermal shield.

3. The thermal enclosure of claim 1, wherein each of the DSC units comprises a reference platform for receiving a reference cell of the DSC unit and a sample platform for receiving a sample cell of the DSC unit.

4. The thermal enclosure of claim 1, wherein the plurality of DSC units is arranged in a plurality of columns, and the second thermal shield includes a section for positioning about each column.

5. The thermal enclosure of claim 1, wherein the first thermal shields and the second thermal shield are formed of aluminum.

6. The thermal enclosure of claim 1, wherein the first thermal shields provide an insulating function about the individual DSC units and the second thermal shield provides another layer of thermally controlled material about the first thermal shields.

7. A microfluidic device (MFD) protective lid, comprising:
a spring element;
a base element; and
at least one pin extending between the spring element and the base element to apply a vertical force from the spring element to at least one MFD under the base element.

8. The MFD protective lid of claim 7, wherein the spring element comprises:
a capping element constructed and arranged for positioning over the at least one pin to provide the vertical force to the at least one pin;
a first serpentine spring extending horizontally from a first side of the capping element; and
a second serpentine spring extending horizontally from a second side of the capping element, wherein the first and second serpentine springs are constructed and arranged to allow an elasticity of the capping element relative to the at least one pin.

9. The MFD protective lid of claim 8, wherein the capping element, the first serpentine spring, and the second serpentine spring extend along a same horizontal plane, are of a same thickness, and are formed of a common material.

10. The MFD protective lid of claim 7, wherein the least one pin includes a first pin and a second pint, and wherein the spring element comprises:
a first capping element constructed and arranged for positioning over the first pin, which provides the vertical force to a DSC unit reference chip of the at least one MFD;
a second capping element constructed and arranged for positioning over the second pin, which provides the vertical force to a DSC unit sample chip of the at least one MFD;
first and second serpentine springs extending horizontally from each of the first and second capping elements to allow an elasticity of the first and second capping element relatives to the first and second pins, respectively.

11. The MFD protective lid of claim 7, wherein the spring element is formed of a spring steel material, the base element is formed of aluminum, and the at least one PIN is formed of a polymer.

12. The MFD protective lid of claim 7, wherein the at least one MFD includes:
a base layer including a serpentine channel at least partially filled with a sample;
a cover slip layer positioned over the base layer; and
an adhesive that couples the base layer to the cover slip layer, and wherein the adhesive and the vertical force applied to the at least one pin provide a seal for the at least one MFD.

13. The MFD protective lid of claim 12, wherein the seal prevents an escape of the sample from the at least one MFD during a temperature change.

14. The MFD protective lid of claim 7, wherein the at least one MFD includes a plurality of sample and reference cells arranged in a tray, wherein the at least one pin includes one pin for each of the plurality of sample and reference chips that provides a substantially uniform force and thermal path for the plurality of sample and reference cells.

15. The MFD protective lid of claim 7, further comprising at least one locking mechanism that applies a vertical force to the spring element, which in turn applies a vertical force to the at least one pin.

16. The MFD protective lid of claim 7, wherein the base layer includes a first hole and a second hole positioned about a first guidepost and a second guidepost extending from an instrument housing the at least one MFD, and wherein the at least one locking mechanism includes a first locking mechanism that is positioned about the first guidepost and a second locking mechanism that is positioned about the second guidepost.

17. A method for preparing a microfluidic chip for a calorimeter instrument, comprising:
preparing a tray of microfluidic chips;
preparing a cover slip cartridge for the microfluidic chips;
filling, by at least one pipette, each of the microfluidic chips with a sample;
placing a cover slip from the cover slip cartridge over the microfluidic chips;
applying a sample press to couple the cover slip to each microfluidic chip.

18. The method of claim 17, wherein preparing the cover slip cartridge includes:
removing the cartridge from a vacuum sealed bag;
opening a release tray to remove the cover slips from the cover slip cartridge;
placing the cover slip cartridge in the release tray so that the cover slips are facing up;
closing the release tray to apply a force to a leveling plane; and
removing the leveling plane to reveal the cover slips.

19. A method for loading a sample into a calorimeter instrument, comprising:
lifting a lid of the calorimeter instrument to access inner lids;
removing the inner lids;
placing a plurality of biologic sample chips each with an attached cover clip and arranged into columns into the interior of the calorimeter instrument;
placing the inner lids over tops of columns of the biologic sample chips; and
lowering an outer lid and a latch instrument so that the calorimeter instrument can perform an operation on the biologic sample chips.
